(19) United States
(12) Patent Application Publication
(10) Pub. No.: US 2012/0137300 A1
(43) Pub. Date: May 31, 2012

(54) Information Processor and Information Processing Method

(76) Inventor: Ryuji Sakai, Saitama (JP)

(21) Appl. No.: 13/165,486

(22) Filed: Jun. 21, 2011

(30) Foreign Application Priority Data
Nov. 30, 2010 (JP) 2010-267711

(51) Int. Cl. G06F 9/46

(52) U.S. Cl. 718/102

(57) ABSTRACT

According to one embodiment, an information processor includes a plurality of execution units, a storage, a generator, and a controller. The storage stores a plurality of basic modules executable asynchronously with another module and a parallel execution control description that defines an execution rule for the basic modules. The generator generates a task graph in which nodes indicating a plurality of tasks relating to the execution of the basic modules are connected by an edge according to the execution order of the tasks, and the nodes and a node of another module in a data dependency relationship are connected by the edge. The controller controls the assignment of the basic modules to the execution units based on the execution rule. The execution units each function as the generator for a basic module to be processed according to the assignment and executes the basic module according to the task graph.

### CROSS-REFERENCE TO RELATED APPLICATIONS

This application is based upon and claims the benefit of priority from Japanese Patent Application No. 2010-267711, filed Nov. 30, 2010, the entire contents of which are incorporated herein by reference.

### FIELD

Embodiments described herein relate generally to an information processor and an information processing method.

### BACKGROUND

Multithread processing has been developed as a multi-core program execution model. In the multithread processing, a plurality of threads as execution units operate in parallel, and exchange data with a main memory to perform parallel processing.

An example of an execution mode of the parallel processing comprises two elements, i.e., runtime processing including a scheduler assigning a plurality of execution units to each of execution units (central processing unit (CPU) cores), and a thread that operates on each of the execution units. In the parallel processing, synchronization between threads is important. If the synchronization is performed inappropriately, for example, deadlock, loss of data consistency, or the like occur. Therefore, scheduling is generally performed on the execution order of the threads to perform the parallel processing based on the schedule so that synchronization between the threads is maintained.

In the conventional technology, since the processing is split based on the transfer (reading and writing) of data from and to a main memory, the scheduling can be performed in rough execution units only. Therefore, even if data dependencies are present in more detailed processing (task), the scheduling in consideration of the dependencies cannot be performed, which leaves room for improvement in view of the efficiency of the parallel processing.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of an information processor according to an embodiment;

FIG. 2 is an exemplary view for explaining a program execution environment in the embodiment;

FIG. 3 is an exemplary view of typical multithread processing;

FIG. 4 is an exemplary view of a parallel execution control description in the embodiment;

FIG. 5 is an exemplary flowchart of a task graph generation process performed by the information processor in the embodiment;

FIG. 6 is an exemplary view for explaining the operation of generating task graph data by the task graph generation process illustrated in FIG. 5 in the embodiment;

FIG. 7 is an exemplary view for explaining the operation of generating task graph data by the task graph generation process illustrated in FIG. 5 in the embodiment;

FIG. 8 is an exemplary view for explaining the operation of generating task graph data by the task graph generation process illustrated in FIG. 5 in the embodiment;

FIG. 9 is an exemplary flowchart of a task graph execution process performed by the information processor in the embodiment; and

FIG. 10 is an exemplary view of the task graph data generated when the information processor uses a prefetch function in the embodiment.

### DETAILED DESCRIPTION

In general, according to one embodiment, an information processor comprises a plurality of execution units, a storage, a generator, and a controller. The storage is configured to store a plurality of basic modules executable asynchronously with another module and a parallel execution control description that defines an execution rule for the basic modules. The generator is configured to generate a task graph in which nodes indicating a plurality of tasks relating to the execution of the basic modules are connected by an edge in accordance with the execution order of the tasks, and the nodes and a node of another module in a data dependency relationship are connected by the edge. The controller is configured to control the assignment of the basic modules to the execution units based on the execution rule. Each of the execution units is configured to function as the generator for a basic module to be processed in accordance with the assignment by the controller and to execute the basic module in accordance with the task graph.

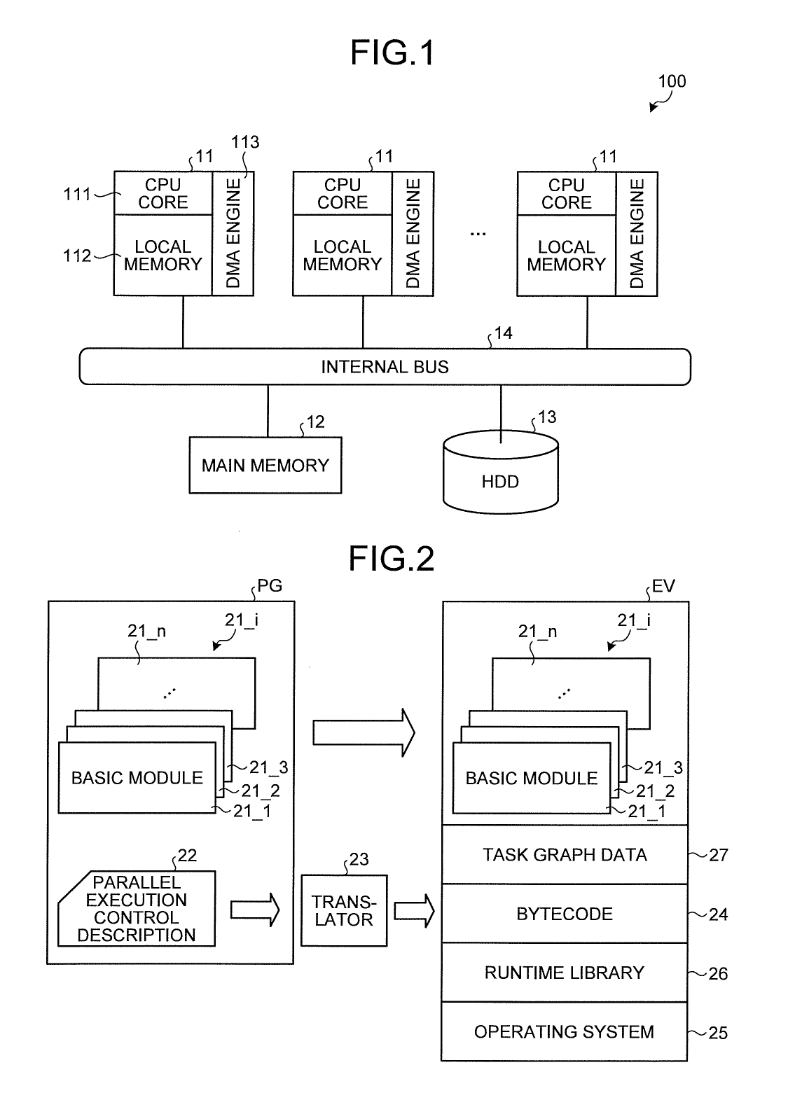

FIG. 1 illustrates an example of an information processor 100 according to an embodiment. The information processor 100 may be, for example, a personal computer (PC), an image (video) processing device, or the like. As illustrated in FIG. 1, the information processor 100 comprises a plurality of processors 11, a main memory 12, and a hard disk drive (HDD) 13, which are connected via an internal bus 14 such as a common bus and an interconnect.

The processor 11 interprets a program code stored in various types of storage devices, such as the main memory 12 and the HDD 13, to perform processing described in advance as a program. The number of the processors 11 is not particularly restricted as long as it is plural. The processors 11 need not have capacities equivalent to each other, and may include a processor having a processing capacity different from those of the others, or a processor processing different types of codes.

The processor 11 comprises a CPU core 111, a local memory 112, and a direct memory access (DMA) engine 113. The CPU core 111 is an arithmetic unit that is a core of the processor 11, and functions as an execution core during parallel processing. The local memory 112 is a memory dedicated for the processor 11, and used as a work area for the CPU core 111. The DMA engine 113 is a dedicated module for data transfer (DMA transfer) between the local memory 112 and the main memory 12.

The main memory 12 is a storage device comprising, for example, a semiconductor memory such as a dynamic random access memory (DRAM). The program to be processed by the processor 11 is loaded into the main memory 12 accessible at relatively high speed before the processing, and is accessed by the processor 11 in accordance with the processing contents described in the program.

The HDD 13 may be, for example, a magnetic desk device and stores in advance a program PG, an operating system 25, a runtime library 26, and the like (see FIG. 2) for the parallel processing, which will be described later. The HDD 13 stores a large amount of data compared with the main memory 12. The processor 11 is configured to load only a part to be processed among the program codes stored in the HDD 13 into the local memory 112.

Although not illustrated, a display for displaying a processing result of the program performed by the processor 11 and the like, and an input/output device such as a keyboard for inputting data and the like are connected to the information processor 100 via a cable or the like.

The information processor 100 with the plurality of processors 11 (the CPU cores 111) mounted thereon can execute a plurality of programs in parallel, and can also execute a plurality of processes in one program in parallel. With reference to FIG. 2, a description will be given of a schematic configuration of a program for the parallel processing executed by the information processor 100.

As illustrated in FIG. 2, the program PG for the parallel processing executed by the information processor 100 comprises a plurality of basic modules 21_{—}i (i=1 to n), and a parallel execution control description 22 that defines the order in which the basic modules 21_{—}i are to be executed. FIG. 2 illustrates the program execution environment of the information processor 100.

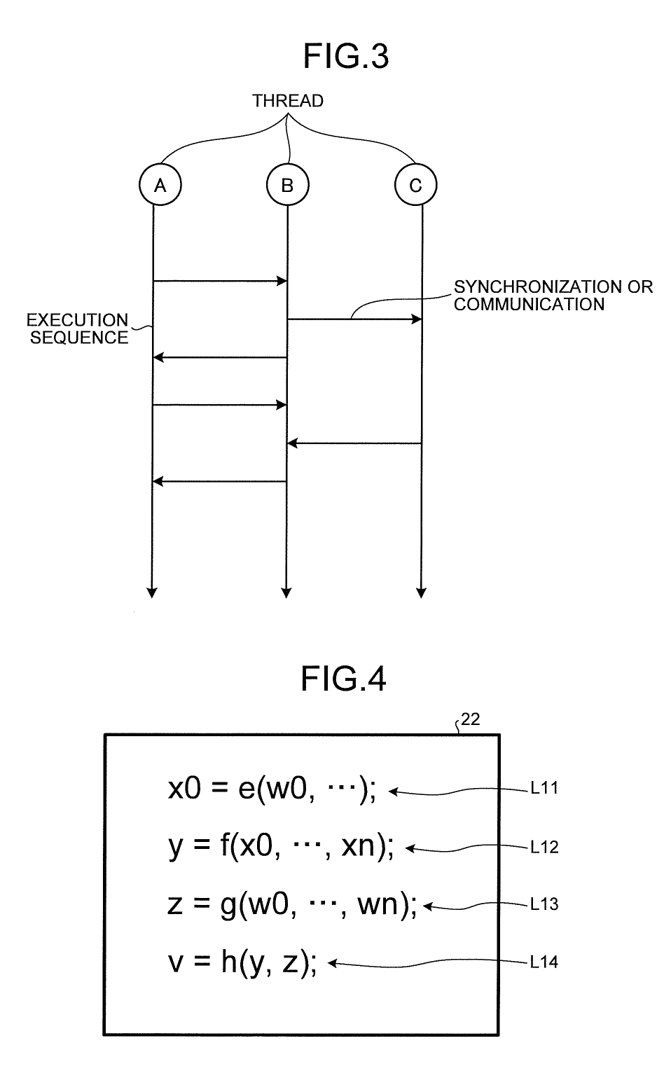

Generally, in multithread processing, as illustrated in FIG. 3, threads proceeds processing in synchronization with other threads (including communication), i.e., while maintaining the consistency of the entire program. Therefore, if waiting for the synchronization occurs frequently, expected parallel performance may not be achieved.

Therefore, in the embodiment, by dividing the program into processing units that are executable asynchronously, i.e., without need for synchronization between modules, the plurality of basic modules 21_{—}i are created, and the parallel execution control description 22 that defines time-series execution rules for the basic modules 21_{—}i is created. In this manner, the basic module 21_{—}i represents a module in the processing unit that is executable asynchronously with other modules. The basic module 21_{—}i herein, for example, corresponds to “Atom” in a parallel programming model “Molatomium”. The parallel execution control description 22 corresponds to, for example, “Mol” in the parallel programming model “Molatomium”.

FIG. 4 illustrates an example of the parallel execution control description 22. In FIG. 4, functions (e ( ), f ( ), g ( ), and h ( )) of lists L11 to L14 correspond to the basic modules 21_{—}i (i=1 to 4), respectively. The functions can operate in parallel as long as there is no data transfer. The parallel execution control description 22 defines the data dependencies between the functions by the relationship between input/output operands. In FIG. 4, although the parallel execution control description 22 is represented by using syntax according to C language, it is not limited thereto. The language in which the basic module 21_{—}i is described is not particularly restricted, and, for example, C language or C++ language can be used.

Referring back to FIG. 2, during the execution of the program PG, the basic modules 21_{—}i are fed into the main memory 12 as they are. The parallel execution control description 22 is converted (compiled) into a bytecode 24 by a translator 23, and loaded into the main memory 12. The translator 23 is realized in cooperation between any one of the processors 11 (the CPU cores 111) and a predetermined program.

As a result, the software configuration of the program PG during the execution comprises the basic modules 21_{—}i and the bytecode 24 as illustrated in an execution environment EV in FIG. 2. The execution environment EV comprises the operating system 25 and the runtime library 26. The execution environment EV comprises task graph data 27 generated from the bytecode 24 by the runtime library 26.

The operating system 25 controls and manages the operation of the entire system, such as the scheduling (assignment) of the hardware and the tasks (basic modules) in the information processor 100. By introducing the operating system 25, when the basic modules 21_{—}i are executed, a programmer can be freed from cumbersome management of the system, and concentrate on programming. In addition, software generally capable of operating in a new product can be developed.

The runtime library 26 comprises an Application Interface (API) used for executing the basic modules 21_{—}i on the information processor 100, and has a function for realizing exclusive control required for performing the parallel processing of the basic modules 21_{—}i.

The runtime library 26 extracts a part relating to a target basic module 21_{—}i to be processed from the bytecode 24 loaded into the main memory 12, and generates the task graph data 27 including information on another basic module 21_{—}i prior to the target basic module 21_{—}i (hereinafter, referred to as “prior module”), and information on still another basic module 21_{—}i subsequent to the target basic module 21_{—}i (hereinafter, referred to as “subsequent module”).

Specifically, the CPU core 111 (hereinafter, referred to as the “processor 11”) of each of the processors 11 uses the function of the runtime library 26 to split the sequential processing required for executing the target basic module 21_{—}i of the processor 11 into five tasks, and generates task nodes each indicating each of the tasks. The five tasks herein represent a task for allocating a memory area to store an argument and a return value of the basic module 21_{—}i in the local memory 112 of the processor 11, a task for loading the argument of the basic module 211 into the allocated memory area, a task for executing the basic module 21_{—}i practically, a task for writing the execution result (return value) of the basic module 21_{—}i to the main memory 12, and a task for deallocating the memory area allocated for the basic module 21_{—}i.

Each of the processors 11 registers the generated task nodes in the task graph data 27, and connects the task nodes by an edge in accordance with the data dependency relationship (arguments and return values) between the task nodes to define a task flow indicating the process of each of the tasks. Each of the processors 11 executes the basic module 21_{—}i to be processed by the processor 11 based on the task flow defined in the task graph data 27, thereby realizing the parallel processing.

In this manner, in the embodiment, the parallel execution control description 22 compiled into the bytecode 24 is converted into the task graph data 27, and the processors 11 that interpret and execute the task graph data 27 are caused to operate in parallel, which realizes the parallel processing. The definition of the task flow may be made before the execution of the basic module 21_{—}i. Alternatively, it may be generated sequentially during the execution of the basic module 21_{—}i by a runtime task or the like.

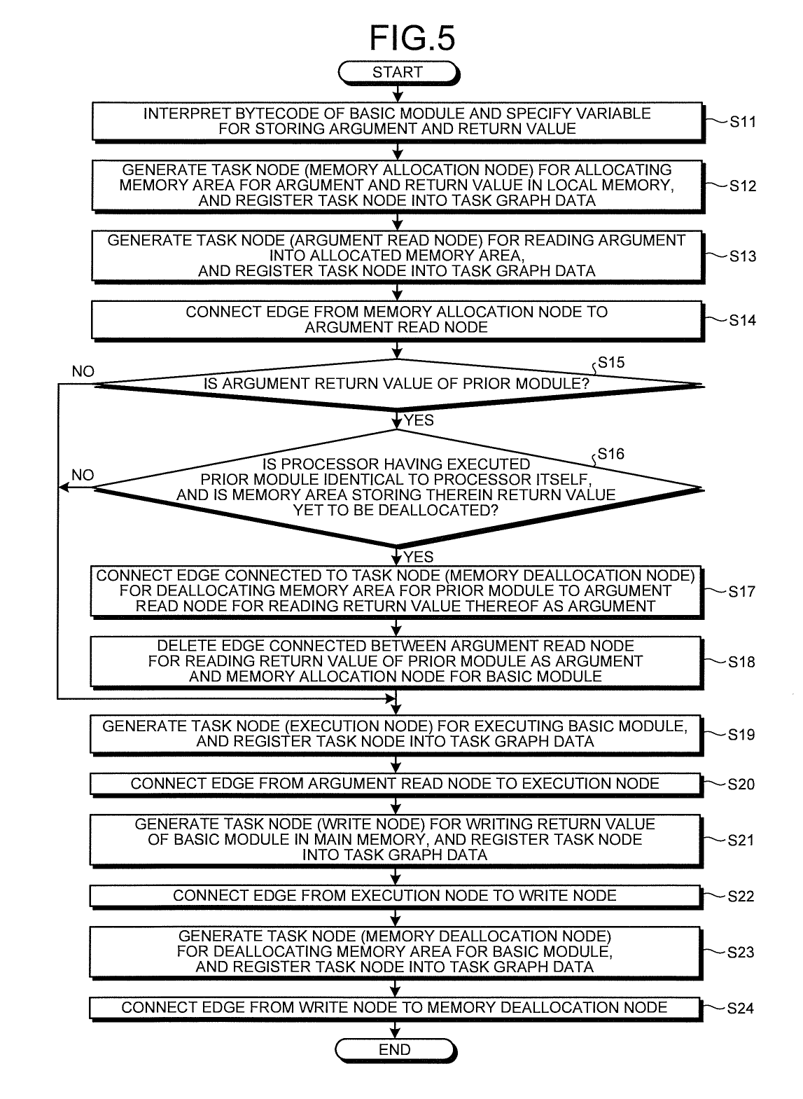

With reference to FIGS. 5 to 8, the generation of the task graph data 27 will now be described. FIG. 5 is a flowchart of a task graph generation process performed in cooperation between the processor 11 and the runtime library 26.

First, the processor 11 that executes the runtime library 26 (hereinafter, simply referred to as the “processor 11”) interprets a description (instruction part) of the basic module 21_{—}i (function) to be processed by the processor 11 in the bytecode 24 loaded into the main memory 12, and specifies an argument of the basic module 21_{—}i and a variable for storing a return value (hereinafter, simply referred to as “return value”) (S11).

The processor 11 generates a task node (hereinafter, referred to as “memory allocation node”) for allocating a memory area for the argument and the return value, and registers the task node into the task graph data 27 (S12). Subsequently, the processor 11 generates a task node (hereinafter, referred to as “argument read node”) for loading the argument specified at S11 into the memory area allocated in the local memory 112 of the processor 11, and registers the task node into the task graph data 27 (S13). The processor 11 then connects an edge from the memory allocation node generated at S12 to the argument read node generated at S13 (S14).

Subsequently, the processor 11 determines whether the argument specified at S11 is a return value of another module 211 prior thereto (prior module) (S15). If the processor 11 determines that the argument is not the return value of the prior module (No at S15), the system control moves to S19 immediately.

If the processor 11 determines that the argument is the return value of the prior module (Yes at S15), the processor 11 determines whether the processor 11 having processed the prior module is the processor 11, and whether the memory area storing the return value of the prior module is yet to be deallocated (S16).

With regard to the argument determined to satisfy the conditions of S16 (Yes at S16), the processor 11 reconnects an edge connected to a task node (hereinafter, referred to as “memory deallocation node”) for deallocating the memory area for the prior module to an argument read node for reading the return value as the argument (S17). The processor 11 then deletes the edge connected between the argument read node and the memory allocation node that has been connected (S18), and the system control moves to S19.

If the processor 11 having processed the prior module is not the processor 11, or even if it is the processor 11, in the case where the memory area has already been deallocated (No at S16), the system control moves to S19.

The processor 11 generates a task node (hereinafter, referred to as “execution node”) for executing the target basic module 21_{—}i to be processed, and registers the task node into the task graph data 27 (S19). The processor 11 then connects an edge from the argument read node generated at S13 to the execution node generated at S19 (S20).

Subsequently, the processor 11 generates a task node (hereinafter, referred to as “write node”) for writing the return value of the executed basic module 21_{—}i to the main memory 12, and registers the task node into the task graph data 27 (S21). The processor 11 then connects an edge from the execution node generated at S19 to the write node generated at S21 (S22). If the edge is reconnected at S17, the processor 11 connects an edge from the execution node to the memory allocation node for the prior module to which the edge is reconnected.

Subsequently, the processor 11 generates a memory deallocation node for deallocating the memory area in the local memory 112 allocated for executing the target basic module 21_{—}i to be processed, and registers the memory deallocation node into the task graph data 27 (S23). The processor 11 then connects an edge from the write node generated at S21 to the memory deallocation node generated at S23 (S24). Then the process ends.

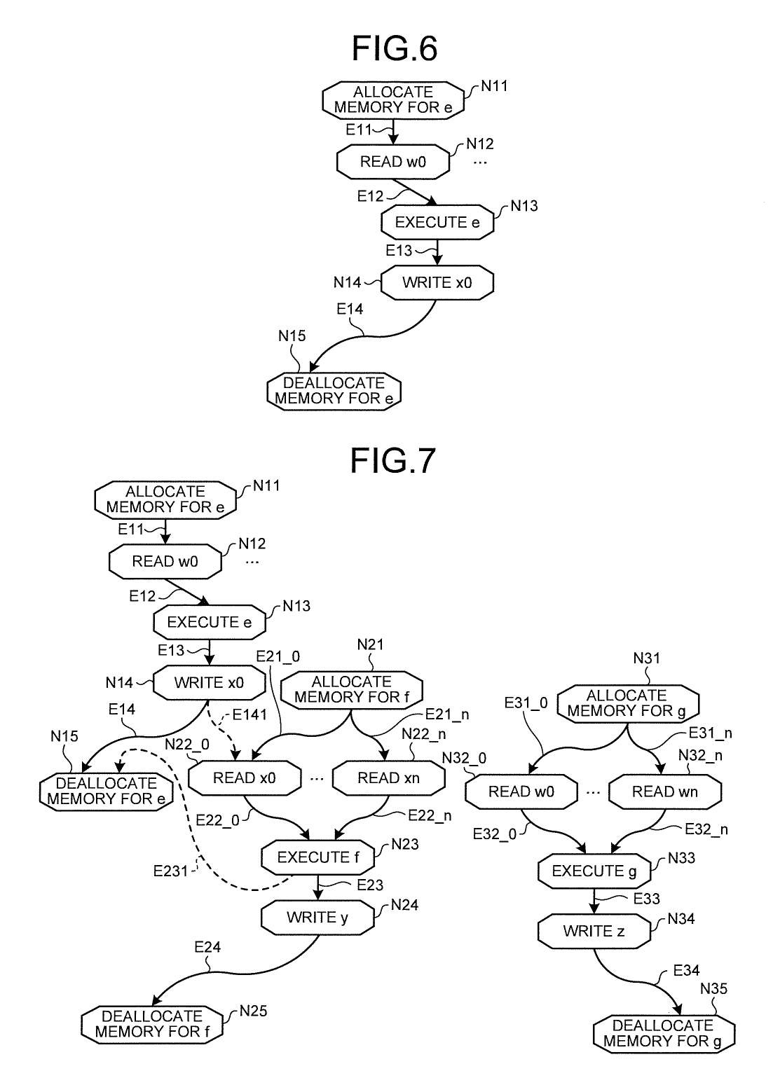

With reference to FIGS. 6 to 8, a specific example of the task graph generation process described above will be explained. As an example, FIGS. 6 to 8 illustrate the operation performed for generating the task graph data 27 from the bytecode of the parallel execution control description 22 illustrated in FIG. 4.

First, the processor 11 that executes the function e ( ) generates a task flow including five task nodes required for executing the function e ( ) from the bytecode of the list L11.

Specifically, the processor 11 that executes the function e ( ), as illustrated in FIG. 6, generates a memory allocation node N11 for the function e ( ), and an argument read node N12 for reading arguments (w0, . . . ), and connects the memory allocation node N11 and the argument read node N12 by an edge E11.

Because the function e ( ) has no argument equivalent to a return value of the prior module, the processor 11 that executes the function e ( ) generates an execution node N13 for executing the function e ( ), and connects the execution node N13 to the argument read node N12 by an edge E12. Subsequently, the processor 11 that executes the function e ( ) generates a write node N14 for writing a return value “x0” of the function e ( ) to the main memory 12, and connects the write node N14 to the execution node N13 by an edge E13. The processor 11 that executes the function e ( ) then generates a memory deallocation node N15 for deallocating the memory area allocated by the memory allocation node N11, and connects the memory deallocation node N15 to the write node N14 by an edge E14.

The processor 11 that executes the function f ( ) generates a task flow including five task nodes required for executing the function f ( ) from the bytecode of the list L12.

Specifically, the processor 11 that executes the function f ( ), as illustrated in FIG. 7, generates a memory allocation node N21 for the function f ( ), and argument read nodes N22_i (i=0 to n) for reading arguments (x0 to xn), and connects the memory allocation node N21 and the argument read nodes N22_i by edges E21_i (i=0 to n), respectively.

In the function f ( ), because the return value “x0” of the function e ( ) as the prior module is used for the argument, the function f ( ) is to be judged at S16. If the function e ( ) and the function f ( ) are executed by the processers 11 different from each other, or even in the case where the functions are executed by an identical processor 11, if the memory area storing the return value “x0” has already been deallocated, the edge E210 is remained as it is.

If the function e ( ) and the function f ( ) are executed by the identical processor 11, and the memory area storing the return value “x0” is yet to be deallocated, the processor 11 that executes the function f ( ) reconnects the edge E14 connected to the memory deallocation node N15 to the argument read node N22_0 for reading an argument “x0” (refer to a dashed line E141), and deletes the edge E21_0.

The processor 11 that executes the function f ( ) then generates an execution node N23 for executing the function f ( ) and connects the execution node N23 to the argument read nodes N22_i by edges E22_i (i=0 to n), respectively. If the edge is reconnected to the argument read node N22_0, the processor 11 connects an edge from the execution node N23 to the memory deallocation node N15 (refer to a dashed line E231), thereby scheduling the deallocation of the memory area.

Subsequently, the processor 11 that executes the function f ( ) generates a write node N24 for writing a return value “y” of the function f ( ) to the main memory 12, and connects the write node N24 to the execution node N23 by an edge E23. The processor 11 that executes the function f ( ) then generates a memory deallocation node N25 for deallocating the memory area allocated by the memory allocation node N21, and connects the memory deallocation node N25 to the write node N24 by an edge E24.

The processor 11 that executes the function g ( ) generates a task flow including five task nodes required for executing the function g ( ). With regard to the bytecode of the list L13, because no argument of the function g ( ) depends on the function e ( ) and the function f ( ), the processor 11 that executes the function g ( ) performs the processing in parallel with the other processors 11.

Specifically, the processor 11 that executes the function g ( ), as illustrated in FIG. 7, generates a memory allocation node N31 for the function g ( ), and argument read nodes N32_i (i=0 to n) for reading arguments (w0 to wn), and connects the memory allocation node N31 and the argument read nodes N32_i by edges E31_i (i=0 to n), respectively.

Because the function g ( ) has no argument equivalent to a return value of the prior module, the processor 11 that executes the function g ( ) generates an execution node N33 for executing the function g ( ), and connects the execution node N33 to the argument read nodes N32_i by an edge E32, respectively. Subsequently, the processor 11 that executes the function g ( ) generates a write node N34 for writing a return value “z” of the function g ( ) to the main memory 12, and connects the write node N34 to the execution node N33 by an edge E33. The processor 11 that executes the function g ( ) then generates a memory deallocation node N35 for deallocating the memory area allocated by the memory allocation node N31, and connects the memory deallocation node N35 to the write node N34 by an edge E34.

The processor 11 that executes the function h ( ) generates a task flow including five task nodes relating to the execution of the function h ( ) from the bytecode of the list L14.

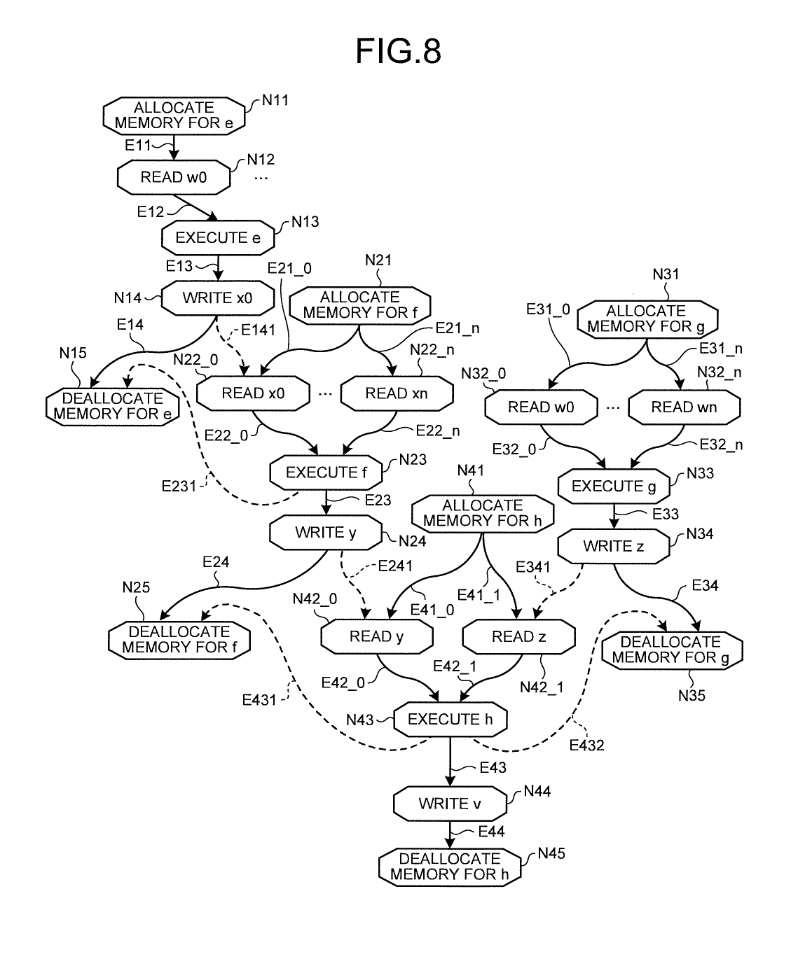

Specifically, the processor 11 that executes the function h ( ), as illustrated in FIG. 8, generates a memory allocation node N41 for the function h ( ), and argument read nodes N42_i (i=0 and 1) for reading arguments (y and z), and connects the memory allocation node N41 and the argument read nodes N42_i by edges E41_i (i=0 and 1), respectively.

In the function h ( ), because the return value “y” of the function f ( ) and the return value “z” of the function g ( ), which the functions are the prior modules, are used for the arguments, the function h ( ) is to be judged at S16. If the function f ( ) and the function h ( ) are executed by the processers 11 different from each other, or even in the case where the functions are executed by an identical processor 11, if the memory area storing the return value “y” has already been deallocated, the edge E41_0 is remained as it is.

If the function f ( ) and the function h ( ) are executed by the identical processor 11, and the memory area storing the return value “y” is yet to be deallocated, the processor 11 that executes the function h ( ) reconnects the edge E24 connected to the memory deallocation node N25 to the argument read node N42_0 for reading the return value “y” as the argument (refer to a dashed line E241), and deletes the edge E41_0.

As for the return value “z” of the function g ( ), the function g ( ) is to be judged at S16 in the same manner. If the function g ( ) and the function h ( ) are executed by the processers 11 different from each other, or even in the case where the functions are executed by an identical processor 11, if the memory area storing the return value “z” has already been deallocated, the edge E41_1 is remained as it is. If the function g ( ) and the function h ( ) are executed by the identical processor 11, and the memory area storing the return value “z” is yet to be deallocated, the processor 11 that executes the function h ( ) reconnects the edge E34 connected to the memory allocation node N35 to the argument read node N42_1 for reading the return value “z” as the argument (refer to a dashed line E341), and deletes the edge E41_1.

The processor 11 that executes the function h ( ) then generates an execution node N43 for executing the function h ( ), and connects the execution node N43 to the argument read nodes N42_i by edges E42_i (i=0 and 1), respectively. If the edge is reconnected to the argument read node N42_0 or N42_1, the processor 11 connects an edge from the execution node N43 to the memory deallocation node N25 or N35 (refer to a dashed lines E431 and E432), thereby scheduling the deallocation of the memory area.

Subsequently, the processor 11 that executes the function h ( ) generates a write node N44 for writing a return value “v” of the function h ( ) to the main memory 12, and connects the write node N44 to the execution node N43 by an edge E43.

The processor 11 that executes the function h ( ) then generates a memory deallocation node N45 for deallocating the memory area allocated by the memory allocation node N41, and connects the memory deallocation node N45 to the write node N44 by an edge E44.

In this manner, the information processor 100 according to the embodiment generates a task flow including five task nodes required for executing the basic module 21_{—}i. In addition, when a return value stored in the local memory 112 of the processor 11 can be referred to for an argument of other processing, the information processor 100 performs scheduling such that the processing proceeds while referring to the return value. This can prevent unnecessary access to the main memory 12, thereby making it possible to improve the efficiency of the parallel processing.

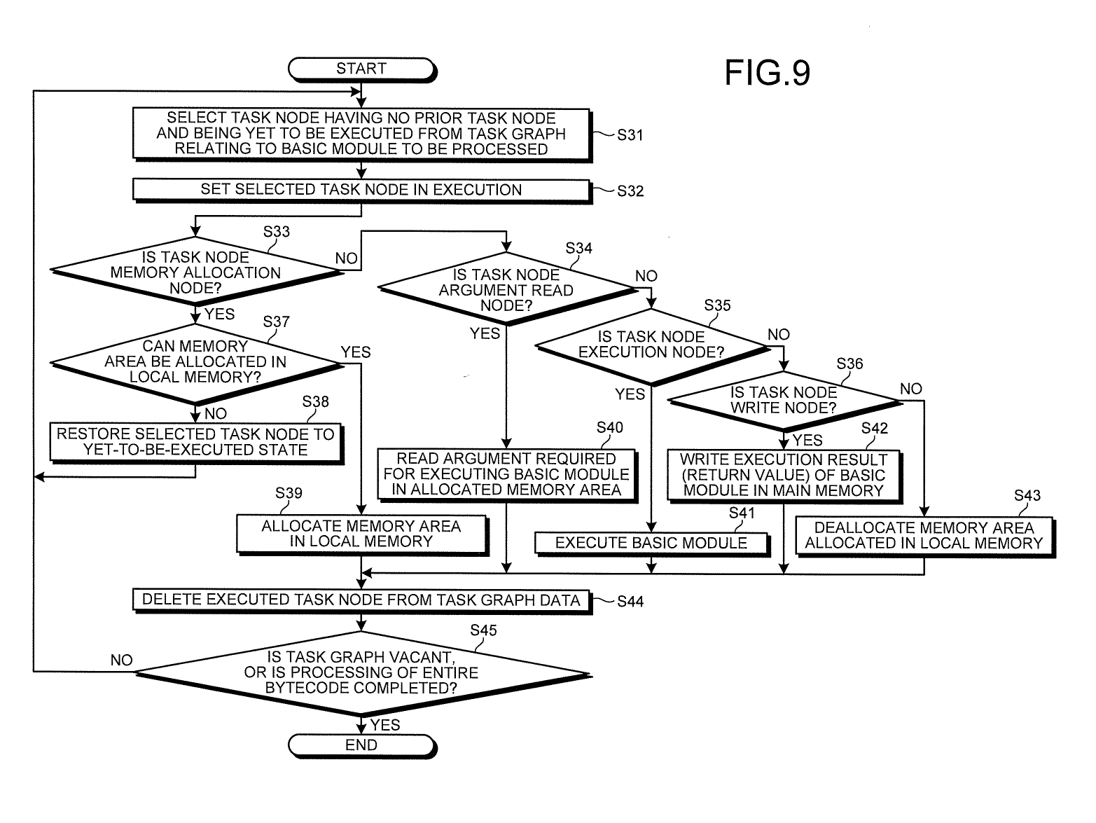

With reference to FIG. 9, execution of the task graph will now be described. FIG. 9 is a flowchart of a task graph execution process performed in cooperation between the processor 11 and the runtime library 26. The process is performed together with the task graph generation process described above in each of the processors 11.

First, the processor 11 selects a task node that has no task node prior thereto, and is yet to be executed from the task flow relating to the basic module 21_{—}i to be executed by the processor 11 (S31). If there is no executable task node in the task graph, the task graph generation process described above is proceeded.

Subsequently, the processor 11 sets the task node selected at S31 in execution (S32) and determines the type of the task node set in execution (S33 to S36). If the task node is determined to be the “memory allocation node” (Yes at S33), the processor 11 determines whether a memory area can be allocated in the local memory of the processor 11 (S37).

If the processor 11 determines that the memory area cannot be allocated because of lack of available memory or the like (No at S37), the processor 11 restores the task node (memory allocation node) to a yet-to-be-executed state, and registers the task node at the end in the execution queue (S38). The system control is then returned to S31. If the processor 11 determines that the memory area can be allocated (Yes at S37), the processor 11 performs the task of the memory allocation node to allocate the memory area in the local memory (S39), and the system control moves to S44.

If the task node is determined to be the “argument read node” (No at S33, Yes at S34), the processor 11 performs the task of the argument read node to issue a DMA command for reading the argument of the target basic module 21_{—}i to be executed, and stores the argument in the memory area allocated at S39 (S40). The system control then moves to S44.

If the task node is determined to be the “execution node” (No at S33, No at S34, Yes at S35), the processor 11 performs the task of the execution node to execute the target basic module 21_{—}i to be processed (S41), and the system control moves to S44.

If the task node is determined to be the “write node” (No at S33, No at S34, No at S35, Yes at S36), the processor 11 performs the task of the write node, and issues a DMA command for writing a return value that is the execution result at S41 to write the return value to the main memory 12 (S42). The system control then moves to S44.

If the task node is determined to be the “memory deallocation node” (No at S33, No at S34, No at S35, No at S36), the processor 11 performs the task of the memory deallocation node to deallocate the memory area allocated in the local memory 112 (S43), and the system control moves to S44.

The processor 11 deletes the task node of which execution is completed from the task graph data 27 (S44). Subsequently, the processor 11 determines whether the task flow of the basic module 21_{—}i executed by the processor 11 becomes vacant, or whether the processing of the entire bytecode 24 (task graph data 27) is completed (S45). If neither of the conditions is satisfied (No at S45), the system control of the processor 11 is returned to S31. At S45, if one of the conditions is satisfied, the process ends.

As described above, according to the embodiment, the processor 11 performs the process in accordance with the task graph data 27 (task flow) generated in the task graph generation process, thereby making it possible to perform the parallel processing efficiently.

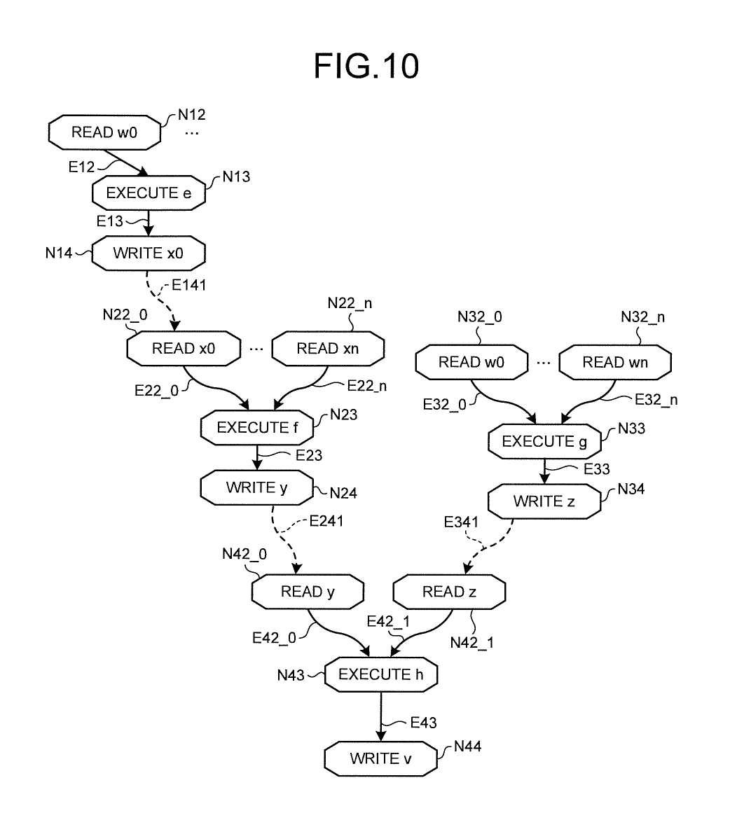

In the embodiment, the allocation/deallocation of the memory area storing the argument and the return value of the basic module is indicated by the task node. Alternatively, for example, if the processor 11 has a prefetch function, the processor 11 may use the prefetch function to allocate/deallocate the memory area. In this case, in the task graph generation process (see FIG. 5) and the task graph execution process (see FIG. 9) described above, the processing for generating the task node relating to the allocation/deallocation of the memory area is not required. Accordingly, for example, the generation result of the task graph generation process where the prefetch function is available in the bytecode of the parallel execution control description 22 illustrated in FIG. 4 is equivalent to the task graph data 27 illustrated in FIG. 8 from which the task nodes and the edges relating to the allocation/deallocation of the memory area are deleted as illustrated in FIG. 10.

Furthermore, while a multiprocessor configuration is described above in which each of the processors 11 comprises the CPU core 111 separately, the embodiment is not so limited. The embodiment may be applied to a multicore configuration in which the one processor 11 comprises the built-in CPU cores 111.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a plurality of execution units;
a storage configured to store a plurality of basic modules executable asynchronously with another module, and a parallel execution control description that defines an execution rule for the basic modules;
a generator configured to generate a task graph in which nodes indicating a plurality of tasks relating to execution of the basic modules are connected by an edge in accordance with an execution order of the tasks, and the nodes and a node of another module in a data dependency relationship are connected by the edge; and
a controller configured to control assignment of the basic modules to the execution units based on the execution rule, wherein
each of the execution units is configured to function as the generator for a basic module to be processed in accordance with the assignment by the controller, and to execute the basic module in accordance with the task graph.

2. The information processor of claim 1, wherein
each of the execution units comprises a dedicated local memory, and
when data required for execution of any of the tasks relating to the execution of the basic modules is stored in an identical local memory, the generator generates the task graph specifying reference to the data stored in the local memory.

3. The information processor of claim 2, wherein the generator is configured to sequentially generate the nodes each indicating an argument read task to read an argument of the basic module, an execution task to execute the basic module on the local memory, and a write task to write an execution result of the execution task to a main memory as a series of tasks relating to execution of the basic module.

4. The information processor of claim 3, wherein the generator is configured to generate a node indicating a memory allocation task to allocate a storage area for the argument and a return value of the basic module in the local memory before generation of a node indicating the argument read task, and to generate a node indicating a memory deallocation task to deallocate the storage area from the local memory after generation of a node indicating the write task.

5. The information processor of claim 4, wherein, if the argument of the basic module to be processed corresponds to a return value of another module, the basic module and the other module are executed by an identical execution unit, and a storage area of the other module is yet to be deallocated, the generator reconnects an edge connected to the node for the memory deallocation task of the other module to the node for the argument read task of the basic module to be processed.

6. The information processor of claim 1, further comprising a converter configured to convert the parallel execution control description into a bytecode, wherein
the generator is configured to interpret an instruction part of the basic module in the bytecode, and to generate the task graph of the basic module.

7. The information processor of claim 1, wherein the execution units are a plurality of central processing units (CPUs) configured separately.

8. The information processor of claim 1, wherein the execution units are a plurality of CPU cores built in one CPU.

9. An information processing method applied to an information processor comprising a plurality of execution units, the information processing method comprising:
generating a task graph in which nodes indicating a plurality of tasks relating to execution of a plurality of basic modules executable asynchronously with another module are connected by an edge in accordance with an execution order of the tasks, and the nodes and a node of another module in a data dependency relationship are connected by the edge; and
controlling assignment of the basic modules to the execution units based on an execution rule defined by a parallel execution control description for the basic modules, wherein
each of the execution units is configured to perform the generating on a basic module to be processed in accordance with the assignment at the controlling, and to execute the basic module in accordance with the task graph.
